(19) United States
(12) Patent Application Publication
(10) Pub. No.: US 2026/0321008 A1
(43) Pub. Date: Oct. 15, 2026

(54) SYSTEM AND METHOD FOR AN AUTOMATIC VIDEO PRODUCTION BASED ON AN OFF-THE-SHELF VIDEO CAMERA

(71) Applicant: PIXELLOT LTD., Petach Tikva (IL)

(72) Inventors: Gal OZ, Kfar Saba (IL); Asaf RONAT, Raanana (IL); Alon WERBER, Shoham (IL)

(73) Assignee: PIXELLOT LTD., Petach Tikva (IL)

(21) Appl. No.: 19/716,411

(22) Filed: Jun. 23, 2026

Related U.S. Application Data
(63) Continuation of application No. 18/319,756, filed on May 18, 2023.
Application No. 18/319,756 is a continuation of application No. PCT/IL2021/051361, filed on Nov. 16, 2021.
(60) Provisional application No. 63/115,732, filed on Nov. 19, 2020.

(51) Int. Cl. G06V 20/40; H04N 5/765; H04N 23/63; H04N 23/698

(52) U.S. Cl. CPC G06V 20/42; G06V 20/49; H04N 5/765; H04N 23/634; H04N 23/698

(57) ABSTRACT

A system and a method of an automatic video production based on an off-the-shelf video camera are provided herein. The method may include receiving, from an off-the-shelf camera, a footage of video image frames containing a scene of a sport event, uploading the footage to a computing device, and processing, by the computing device, the footage to automatically generate a video production of the sport event based on at least a portion of the video frame images.

### CROSS REFERENCE TO RELATED APPLICATIONS

This Application is a continuation of U.S. patent application Ser. No. 18/319,756 filed on May 18, 2023, which is a continuation of PCT Application No. PCT/IL2021/051361 filed on Nov. 16, 2021, which claims the benefit of U.S. Provisional Patent Application No. 63/115,732 filed on Nov. 19, 2020, all of which are incorporated herein by reference in their entireties.

### FIELD OF THE INVENTION

The present invention relates to the field of video production and, more particularly, to an automatic video production based on an off-the-shelf video camera.

### BACKGROUND OF THE INVENTION

A television coverage of sports events may require a large team and several cameras to provide high quality coverage. Handling of such coverage typically requires skilled professionals. Handling of such coverage is typically expensive. Therefore, many semi-professional or amateur sport events are not being covered.

### SUMMARY OF THE INVENTION

Some embodiments of the present invention may provide a method of an automatic video production based on an off-the-shelf video camera, which method may include receiving, from an off-the-shelf camera, a footage of video image frames containing a scene of a sport event, uploading the footage to a computing device, and processing, by the computing device, the footage to automatically generate a video production of the sport event based on at least a portion of the video frame images.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1 is a schematic illustration of a system for an automatic video production based on an off-the-shelf video camera, according to some embodiments of the invention; and

FIG. 2 is a flowchart of a method of an automatic video production based on an off-the-shelf video camera, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units can be at least partially implemented by a computer processor.

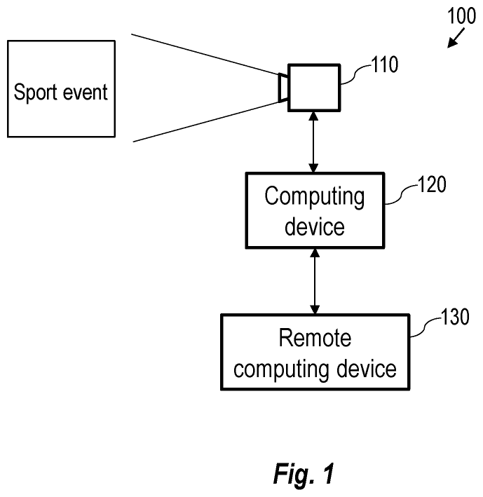

Reference is now made to FIG. 1, which is a schematic illustration of a system 100 for an automatic video production based on an off-the-shelf video camera, according to some embodiments of the invention.

According to some embodiments, system 100 may include a camera 110, a computing device 120 and a remote computing device 130.

Camera 110 may be any off-the-shelf video camera having a relatively high resolution. For example, camera 110 may be a 4K camera having a field-of-view of 28×15 meters. Camera 110 may be, for example, a professional camera, an action camera, etc. Computing device 120 may be, for example, a personal computing device such as a smartphone, a tablet, etc. For example, camera 110 may be a camera of computing device 120. Computing device 120 may be interfaceable with camera 110. Computing device 120 may be interfaceable with remote computing device 130.

Camera 110 may be positioned by a user at a sport facility. Camera 110 may be controlled by the user or computing device 120 may be controlled by the user to cause camera 110 to capture a scene including a sport event to provide a footage of video image frames covering the sport event. The sport event may be, for example, a professional sport event, a semi-professional sport event or an amateur sport event.

The footage may be uploaded, e.g., by the user, to remote computing device 130. The footage may be uploaded directly from camera 110 (e.g., if camera 110 is connected to a network) or using any computing device connected to a network, such as computing device 120. The footage may be uploaded after the sport event has ended or during the sport event.

Remote computing device 130 may process the video image frames of the footage and may automatically generate a video production of the sport event based on at least a portion of the video frame images. For example, remote computing device 130 may generate the video production by creating combinations and reductions of at least a portion the video frame images of the footage (e.g., as described here below).

In some embodiments, remote computing device 130 may push the video production to the user or a group of users. In some embodiments, remote computing device 130 may push the video production after the generation thereof has been complete. In some embodiments, for example when the footage is being uploaded to remote computing device 130 during the sport event, remote computing device 130 may stream the video production being generated in real-time (or substantially in real-time).

In some embodiments, computing device 120 may generate instructions concerning a proper position of camera 110 with respect to a playing field. In some embodiments, the instructions may be general. For example, the user may be instructed to position camera 110 at a position corresponding to a middle of the playing field, to make sure that four corners of the playing field are within the field-of-view of camera 110, etc.

In some embodiments, computing device 120 may analyze at least a portion of the video image frames being captured by camera 110 to evaluate the position of camera 110 with respect to the playing field. In some embodiments, computing device 120 may alert the user in the case of improper position of camera 110 with respect to the playing field. In some embodiments, computing device 120 may generate specific instructions concerning the proper positioning of camera 110 based on the analysis of the video frame images. For example, computing device 120 may detect the middle and/or the corners of the playing field in the video image frames of the footage and instruct the user how to move camera 110 so as to properly position camera 110 with respect to the playing field.

In some embodiments, computing device 120 may determine a condition of camera 110. The condition may, for example, include at least one of settings, temperature, available memory, battery state of charge of camera 110, etc. In some embodiments, computing device 120 may generate notifications concerning the determined condition of camera 110. For example, computing device 120 may notify the user that there is not enough memory or battery for recording the entire sport event, that the settings of camera 110 are improper and/or that camera 110 is overheated, etc. In some embodiments, computing device 120 may generate instructions for the user based on the determined condition of camera 110. For example, computing device 120 may instruct the user to connect camera 110 to a power source, replace a memory card, reset camera 110, etc.

In some embodiments, computing device 120 may determine that camera 110 is not recording the footage. In some embodiments, computing device 120 may generate a notification to the user that camera 110 is not recording the footage. For example, computing device 120 may determine that camera 120 has not started recording the footage during a predefined time interval after the poisoning and/or setting of camera 110 has been complete (e.g., the user may have forgotten to initiate the recording) and/or may generate the respective notification to the user.

In some embodiments, computing device 120 may determine that camera 110 has been moved based on the video frame images of the footage. For example, computing device 120 may compare at least some of the video frame images of the footage and determine that camera 110 has been moved based on the comparison thereof. If the movement of camera 110 is above a predefined threshold, computing device 120 may alert the user and/or instruct the user to reposition camera 110 into a proper position thereof with respect to the playing field (e.g., as described hereinabove). Computing device 120 may tag the movement of camera 110 in the footage so that the footage may be recovered during the processing thereof (e.g., by remote computing device 130) to compensate for the movement of camera 110.

In some embodiments, computing device 120 may receive a sport event related information. For example, computing device 120 may request that the user provide the sport event related information. For example, the sport event related information may include a type of the sport event, a size of the playing field, a distance of camera 110 from the playing field, whether or not a scoreboard is within the field-of-view of camera 110, etc. In some embodiments, computing device 120 may generate a calibration data based on at least a portion of the sport event related information.

In some embodiments, computing device 120 may generate user tag data based on tags of the footage made by the user (e.g., using computing device 120). The user may, for example, tag specific locations on the playing field to be shown in the video production and time periods for which the specific locations to be shown in the video production. For example, the specific locations may be locations at which some practice (e.g., scoring events, faults, etc.) is happening. The user may, for example, tag events in the footage (e.g., a beginning, a half-time and an end of the sport event, faults, scoring events, etc.). The user may, for example, tag team names, player names, etc. The user tag data may be used by remote computing device 130 during generation of the video production.

The computing device, for example computing device 120, may be configured to optimize the uploading of the footage based on an available network bandwidth. For example, the computing device may apply a content layer based compression of the footage when uploading the footage to remote computing device 130, as described hereinbelow.

In some embodiments, the computing device may identify, in the video image frames of the footage, two or more content layers of a set of predetermined content layers. For example, the computing device may identify, in the video image frames of the footage, three content layers—e.g., a first content layer containing images of players on the playing field, a second content layer containing images of a surface of the playing field, and a third content layer containing images of a background scene (e.g., an audience, buildings, etc.). Each of the content layers may have specified compression parameters. The specified compression parameters of each of the content layers may, for example, include at least one of a bandwidth priority, a minimal percent of the available bandwidth, a frame-rate, a resolution to be assigned to the respective content layer, etc. For example, the bandwidth priority, the minimal percent of the available bandwidth, the frame-rate and/or the resolution to be assigned to the first content layer and the second content layer (containing images of players and the playing surface, respectively) may be higher than the bandwidth priority, the minimal percent of the available bandwidth, the frame-rate and/or the resolution to be assigned to the third content layer (containing images of the background scene), respectively. The specified compression parameters for each of the content layers may be predefined or may be defined, or changed, by the user.

The computing device may generate two or more content layer footages, each including image frames containing images of one of the two or more identified content layers. For example, the computing device may generate a first content layer footage including image frames containing images of the first identified content layer (e.g., images of players), a second content layer footage including image frames containing images of the second identified content layer (e.g., images of the playing field surface), and a third content layer footage including image frames containing images of the identified third content layer (e.g., images of the background).

The computing device may compress the two or more content layer footages each based on its respective compression parameters, to generate two or more compressed content layer footages.

The computing device may upload the two or more compressed content layer footages to remote computing device 130. Remote computing device 130 may decode the two or more compressed content layer footages, each based on its respective compression parameters, to generate two or more decoded content layer footages. Remote computing device 130 may fuse the two or more decoded content layer footages into a single footage.

The content layer based compressing of the footage may optimize the uploading of the footage to an available bandwidth by enhancing the quality of preferred content layers as defined by the user, for example, at an expense of other content layers containing less preferred information. This may, for example, significantly decrease the time required for uploading of the footage.

In some embodiments, remote computing device 130 may calibrate the footage. For example, footage may be calibrated based on the calibration data derived from the sport event related information (e.g., provided by the user as described hereinabove). In another example, remote computing device 130 may automatically calibrate the footage. For example, the footage may be calibrated based on points contained within the scene included in the video image frames of the footage. The points may, for example, include at least one of corners of the playing field, crossings of two field lines, etc.

Remote computing device 130 may automatically process footage to generate the video production. The video production may, for example, include a footage of a moving camera view of the sport event or a portion thereof. In another example, the video production may include a footage of a wide panoramic view of the sport event or a portion thereof. In another example, the video production may include a highlight footage of the sport event. In another example, the video production may include a player highlight footage. The video production may include other features as well.

In some embodiments, remote computing device 130 may generate the video production based on the user tag data so as to include in the video production portions of the footage that have been tagged by the user.

In some embodiments, remote computing device 130 may generate the video production including the footage of the moving camera view of the sport event or a portion thereof. Remote computing device 130 may analyze the footage to detect one or more objects associated with a playing object that are associated with the sport event. For example, referring to a soccer match as an example, the one or more objects may be players, and the playing object may be a ball. Remote computing device 130 may derive current and estimated position of the detected one or more objects and of the playing object based on a calibration data. Remote computing device 130 may generate the video production of the sport event by automatically selecting a sequence of portions of the footage of video image frames based on the current and estimated position of the detected one or more objects and of the playing object and/or based on predefined video production rules associated with a type of the sport event. In some embodiments, remote computing device 130 may estimate, upon losing the playing object by one of the objects, a region occupying the playing object in accordance with previous location thereof. In some embodiments, remote computing device 130 may modify the video production of the footage to include the region occupying the playing object.

In some embodiments, remote computing device 130 may generate the video production including the highlight footage. Remote computing device 130 may extract from the footage raw inputs that include audio, video image frames synchronized with the audio and actual sport event time. Remote computing device 130 may extract features to transform the raw inputs into feature vectors by applying low-level processing. The low-level processing may, for example, include utilizing pre-existing knowledge regarding points within the field of view of the camera and identifying and extracting features therefrom. The pre-existing knowledge may, for example, include knowledge about areas of the playing field, knowledge about certain players, and knowledge about how various players move around the playing field, etc. Remote computing device 130 may create segments from the feature vectors and identify specific events in each one of the segments by applying rough segmentation. Remote computing device 130 may determine whether each one of the events is a highlight by applying analytics algorithms. Remote computing device 130 may generate the highlight footage based on the events that have been determined as highlights.

In some embodiments, remote computing device 130 may fuse graphic content into the video production. For example, the graphic content may include a scoreboard, an advertisement content, etc. Remote computing device 130 may derive, for each video image frame of the footage, a virtual camera model that correlates each of pixels of the respective video image frame with a real-world geographic location in the scene associated with the pixel thereof. For example, the virtual camera model may be at least partly derived based on the calibration data. Remote computing device 130 may generate, for each of the video image frames, a foreground mask including pixels relating to the objects of interest. Remote computing device 130 may substitute, in at least a portion of the video image frames of the footage, all pixels in the respective video image frames contained within at least one predefined content insertion region of the background surface, except for the pixels indicated by the respective frames' foreground masks, with pixels of the graphic content, using the virtual camera model of the respective video image frame.

In some embodiments, remote computing device 130 may determine, based on the footage, that camera 110 has been moved based on the video frame images of the footage. For example, remote computing device 130 may compare at least some of the video frame images of the footage and may determine that camera 110 has been moved based on the comparison thereof. In some embodiments, remote computing device 130 may recover the footage to compensate for the movement of camera 110.

Some embodiments of the present invention may provide a non-transitory computer readable medium including one or more subsets of instructions that, when executed, cause a processor of computing device 120 to perform functions as described hereinabove.

Some embodiments of the present invention may provide a non-transitory computer readable medium including one or more subsets of instructions that, when executed, cause a processor of remote computing device 130 to perform functions as described hereinabove.

In various embodiments, at least some of the functions described hereinabove as being performed by computing device 120 may be performed by remote computing device 130 and/or at least some of the functions described hereinabove as being performed by remote computing device 120 may be performed by computing device 120.

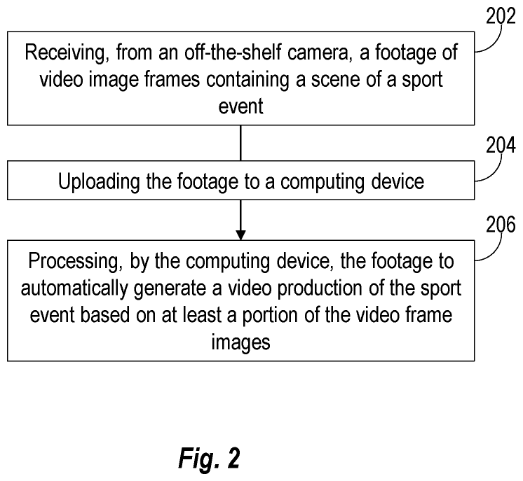

Reference is now made to FIG. 2, which is a flowchart of a method of an automatic video production based on an off-the-shelf video camera, according to some embodiments of the invention.

The method may include receiving 202, from an off-the-shelf camera, a footage of video image frames containing a scene of a sport event. For example, the camera may be any off-the-shelf video camera having a relatively high resolution. For example, the camera may be a 4K camera having a field-of-view of 28×15 meters. The camera may be, for example, a professional camera, an action camera, etc. The camera may be, for example, a camera of a personal computing device such as a smartphone, a tablet, etc. The sport event may be, for example, a professional sport event, a semi-professional sport event or an amateur sport event.

The method may include uploading 204 the footage to a computing device (e.g., a remote computing device, such as remote computing device described above with respect to FIG. 1). Various embodiments may include uploading the footage directly from the off-the-shelf camera (e.g., if the camera is connected to a network) or from any computing device connected to a network. Various embodiments may include uploading the footage after the sport event has ended or during the sport event.

The method may include processing 206, by the computing device, the footage to automatically generate a video production of the sport event based on at least a portion of the video frame images. Some embodiments may include generating the video production by creating combinations and reductions of at least a portion the video frame images of the footage.

Some embodiments may include pushing the video production to a user or a group of users. Some embodiments may include pushing the video production after the generation thereof has been complete. Some embodiments may include streaming the video production in real-time (or substantially in real-time) to the user or the group of users (e.g., when the footage is being uploaded during the sport event).

Some embodiments may include generating instructions concerning a proper position of the off-the-shelf camera with respect to a playing field. The instructions may be, for example, general instructions. For example, the user may be instructed to position the off-the-shelf camera at a position corresponding to a middle of the playing field, to make sure that four corners of the playing field are within the field-of-view of the off-the-shelf camera, etc.

Some embodiments may include analyzing at least a portion of the video image frames being captured by the off-the-shelf camera to evaluate the position of the off-the-shelf camera with respect to the playing field. Some embodiments may include alerting the user in the case of improper position of the off-the-shelf camera with respect to the playing field. Some embodiments may include generating specific instructions concerning the proper positioning of the off-the-shelf camera based on the analysis of the video frame images. For example, some embodiments may include detecting the middle and/or the corners of the playing field in the video image frames of the footage and instructing the user how to move the off-the-shelf camera so as to properly position the off-the-shelf camera with respect to the playing field.

Some embodiments may include determining a condition of the off-the-shelf camera. The condition may, for example, include at least one of settings, temperature, available memory, battery state of charge of the off-the-shelf camera, etc. Some embodiments may include generating notifications concerning the determined condition of the off-the-shelf camera. Some embodiments may include notifying the user that there is not enough memory or battery for recording the entire sport event, that the setting of the off-the-shelf camera are improper and/or that the off-the-shelf camera is overheat, etc. Some embodiments may include generating instructions for the user based on the determined condition of the off-the-shelf camera. For example, some embodiments may include instructing the user to connect the off-the-shelf camera to a power source, replace a memory card, reset the off-the-shelf camera, etc.

Some embodiments may include determining that the off-the-shelf camera is not recording the footage. Some embodiments may include generating a notification to the user that the off-the-shelf camera is not recording the footage. For example, some embodiments may include determining that the off-the-shelf camera has not started recording the footage during a predefined time interval after the poisoning and/or setting of the off-the-shelf camera has been complete (e.g., the user may have forgot to initiate the recording) and/or generating the respective notification to the user.

Some embodiments may include determining that the off-the-shelf camera has been moved based on the video frame images of the footage. For example, some embodiments may include comparing at least some of the video frame images of the footage and determining that the off-the-shelf camera has been moved based on the comparison thereof. If the movement of the off-the-shelf camera is above a predefined threshold, some embodiments may include generating a notification to the user and/or instructing the user to reposition the off-the-shelf camera into a proper position thereof with respect to the playing field (e.g., as described hereinabove). Some embodiments may include tagging the movement of the off-the-shelf camera in the footage so that the movement may be accounted for during processing of the footage.

Some embodiments may include receiving (e.g., from the user) a sport event related information. For example, the sport event related information may include a type of the sport event, a size of the playing field, a distance of the off-the-shelf camera from the playing field, whether or not a scoreboard is within the field-of-view of the off-the-shelf camera, etc. Some embodiments may include generating a calibration data based on at least a portion of the sport event related information.

Some embodiments may include receiving user tag data, the user tag data may include tags of the footage made by the user. The user may, for example, tag specific locations on the playing field to be shown in the video production and time periods for which the specific locations to be shown in the video production. For example, the specific locations may be locations at which some practice (e.g., scoring events, faults, etc.) is happening. The user may, for example, tag events in the footage (e.g., a beginning, a half-time and an end of the sport event, faults, scoring events, etc.). The user may, for example, tag team names, player names, etc.

The user tag data may be used by computing device 130 during generation of the video production.

Some embodiments may include optimizing the uploading of the footage to the computing device based on an available network bandwidth. For example, a content layer based compression of the footage may be applied when uploading of the footage to the computing device.

Some embodiments may include identifying, in the video image frames of the footage, two or more content layers of a set of predetermined content layers. For example, some embodiments may include identifying, in the video image frames of the footage, three content layers—e.g., a first content layer containing images of players on the playing field, a second content layer containing images of a surface of the playing field, and a third content layer containing images of a background scene (e.g., an audience, buildings, etc.). Each of the content layers may have specified compression parameters. The specified compression parameters of each of the content layers may, for example, include at least one of a bandwidth priority, a minimal percent of the available bandwidth, a frame-rate, a resolution to be assigned to the respective content layer, etc. For example, the bandwidth priority, the minimal percent of the available bandwidth, the frame-rate and/or the resolution to be assigned to the first content layer and the second content layer (containing images of players and the playing surface, respectively) may be higher than the bandwidth priority, the minimal percent of the available bandwidth, the frame-rate and/or the resolution to be assigned to the third content layer (containing images of the background scene), respectively. The specified compression parameters for each of the content layers may be predefined or may be defined, or changed, by the user.

Some embodiments may include generating two or more content layer footages, each including image frames containing images of one of the two or more identified content layers. For example, some embodiments may include generating a first content layer footage including image frames containing images of the first identified content layer (e.g., images of players), a second content layer footage including image frames containing images of the second identified content layer (e.g., images of the playing field surface), and a third content layer footage including image frames containing images of the identified third content layer (e.g., images of the background).

Some embodiments may include compressing the two or more content layer footages each based on its respective compression parameters, to generate two or more compressed content layer footages.

Some embodiments may include uploading the two or more compressed content layer footages to the computing device. Some embodiments may include may decoding the two or more compressed content layer footages each based on its respective compression parameters, to generate two or more decoded content layer footages. Some embodiments may include fusing the two or more decoded content layer footages into a single footage.

The content layer based compressing of the footage may optimize the uploading of the footage to an available bandwidth by enhancing the quality of preferred content layers as defined by the user, for example, at an expense of other content layers containing less preferred information. This may, for example, significantly decrease the time required for uploading of the footage.

Some embodiments may include calibrating the footage. Some embodiments may include calibrating the footage based on the calibration data derived from the sport event related information provided by the user (e.g., as described hereinabove). Some embodiments may include automatically calibrating the footage by the computing device. For example, the footage may be calibrated based on points contained within the scene included in the video image frames of the footage. The points may, for example, include at least one of corners of the playing field, crossings of two field lines, etc.

Some embodiments may include automatically processing the footage to generate the video production. In another example, the video production may include a footage of a wide panoramic view of the sport event or a portion thereof. In another example, the video production may include a highlight footage of the sport event. In another example, the video production may include a player highlight footage. The video production may include other features as well.

Some embodiments may include generating the video production at least partly based on the user tag data so as to include in the video production portions of the footage that have been tagged by the user.

Some embodiments may include generating the video production including the footage of the moving camera view of the sport event or a portion thereof. Some embodiments may include analyzing the footage to detect one or more objects associated with a playing object that are associated with the sport event. For example, referring to the soccer match as an example, the one or more objects may be players and the playing object may be a ball. Some embodiments may include deriving current and estimated position of the detected one or more objects and of the playing object based on a calibration data. Some embodiments may include generating the video production of the sport event by automatically selecting a sequence of portions of the footage of video image frames based on the current and estimated position of the detected one or more objects and the playing object and/or based on predefined video production rules associated with a type of the sport event. Some embodiments may include estimating, upon losing the playing object by one of the objects, a region occupying the playing object in accordance with previous location thereof. Some embodiments may include modifying the video production to include the region occupying the playing object.

Some embodiments may include generating the video production including the highlight footage. Some embodiments may include generating the video production including a highlight footage of the sport event. Some embodiments may include generating the video production including a player highlight footage. Some embodiments may include extracting from the footage raw inputs that include audio, video image frames synchronized with the audio and actual sport event time. Some embodiments may include extracting features to transform the raw inputs into feature vectors by applying low-level processing. The low-level processing may, for example, include utilizing pre-existing knowledge regarding points within the field of view of the camera and identifying and extracting features therefrom. The pre-existing knowledge may, for example, include knowledge about areas of the playing field, knowledge about certain players, and knowledge about how various players move around the playing field, etc. Some embodiments may include creating segments from the feature vectors and identify specific events in each one of the segments by applying rough segmentation. Some embodiments may include determining whether each one of the events is a highlight by applying analytics algorithms. Some embodiments may include generating the highlight footage based on the events that have been determined as highlights.

Some embodiments may include fusing graphic content into the video production. For example, the graphic content may include a scoreboard, an advertisement content, etc. Some embodiments may include deriving, for each video image frame of the footage, a virtual camera model that correlates each of pixels of the respective video image frame with a real-world geographic location in the scene associated with the pixel thereof. For example, the virtual camera model may be at least partly derived based on the calibration data. Some embodiments may include generating, for each of the video image frames, a foreground mask including pixels relating to the objects of interest. Some embodiments may include substituting, in at least a portion of the video image frames of the footage, all pixels in the respective video image frames contained within at least one predefined content insertion region of the background surface, except for the pixels indicated by the respective frames' foreground masks, with pixels of the graphic content, using the virtual camera model of the respective video image frame.

Some embodiments may include determining, based on the footage, that the off-the-shelf camera has been moved based on the video frame images of the footage. For example, some embodiments may include comparing at least some of the video frame images of the footage and determine that the off-the-shelf camera has been moved based on the comparison thereof. Some embodiments may include recovering the footage to compensate the movement of the off-the-shelf camera.

The disclosed system and method may enable capturing and automatically generating a video production of a sport event using any off-the-shelf camera positioned at a fixed position on a sport event facility, without a need in moving the camera during the sport event. This may eliminate a need in skilled professionals and spread the field of television coverage of sports events to semi-professional and amateur sport events that are typically not being covered. The system and method may, for example, utilize dedicated artificial intelligence algorithms that may significantly decrease the processing effort needed to generate the video production.

Some embodiments of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions thereof. The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams can represent a module, segment, or portion of code, which includes one or more executable instructions for implementing the specified logical function(s). It should also be noted that, in some alternative implementations, the functions noted in the portion can occur out of the order noted in the figures. For example, two portions shown in succession can, in fact, be executed substantially concurrently, or the portions can sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of processing a video feed for video production for a sports event, the method comprising:
receiving, from an off-the-shelf camera, a footage of video image frames containing a scene of a sport event;
uploading the footage to a computing device; and
processing, by the computing device, the footage to automatically generate a video production of the sport event based on at least a portion of the video frame images,
wherein the method further comprises optimizing the uploading of the footage to the computing device based on an available network bandwidth by:
generating, by the computing device, two or more content layers of a set of predetermined content layers from the video image frames of the footage, wherein each of the content layers has specified compression parameters;
compressing, by the computing device, the two or more content layers each based on its respective compression parameter to generate two or more compressed content layer footages,
wherein the content layers are compressed such that the quality of preferred content layers as defined by a user is enhanced at an expense of other content layers containing less preferred information.

2. The method of claim 1, further comprising generating the video production by creating combinations and reductions of at least a portion the video frame images of the footage.

3. The method of claim 1, further comprising pushing the video production to a user or a group of users.

4. The method of claim 3, further comprising:
uploading the footage during the sport event; and
streaming the video production substantially in real-time.

5. The method of claim 1, further comprising:
alerting a user in the case of an improper position of the off-the-shelf camera with respect to the playing field containing the sport event.

6. The method of claim 1, further comprising:
determining that the off-the-shelf camera is not recording the footage during a predefined time interval after positioning of the off-the-shelf camera has been complete; and
generating the respective notification to the user.

7. The method of claim 1, further comprising:
receiving a sport event related information comprising at least one of a type of the sport event, a size of the playing field, a distance of the off-the-shelf camera from the playing field; and
generating a calibration data based on at least a portion of the sport event related information.

8. The method of claim 7, further comprising calibrating the footage based on points contained within the scene included in the video image frames of the footage, wherein the points comprise at least one of corners of the playing field and crossings of two field lines.

9. The method of claim 1, further comprising:
receiving user tag data comprising tags of the footage made by the user; and
generating the video production at least partly based on the user tag data so as to include in the video production portions of the footage that have been tagged by the user.

10. The method of claim 1, further comprising generating the video production to include a footage of a moving camera view of the sport event.

11. The method of claim 1, further comprising generating the video production to include a footage of a wide panoramic view of the sport event or a portion thereof.

12. The method of claim 1, further comprising generating the video production to include a highlight footage of the sport event.

13. The method of claim 1, further comprising generating the video production to include a player highlight footage.

14. The method of claim 1, further comprising fusing graphic content into the video production.

15. The method of claim 14, wherein the graphic content comprises at least one of: a scoreboard or advertisement content.

16. A system for processing a video feed for video production for a sports event, the system comprising:
an off-the-shelf video camera configured to capture a footage of video image frames containing a scene of a sport event; and
a computing device configured to:
generate two or more content layers of a set of predetermined content layers from the video image frames of the footage, wherein each of the content layers has specified compression parameters;
compress the two or more content layers each based on its respective compression parameter to generate two or more compressed content layer footages,
wherein the content layers are compressed such that the quality of preferred content layers as defined by a user is enhanced at an expense of other content layers containing less preferred information.

17. The system of claim 16, wherein the computing device is further configured to generate the video production by creating combinations and reductions of at least a portion the video frame images of the footage.

18. The system of claim 17, wherein the computing device is further configured to push the video production to a user or a group of users
